(19) United States
(12) Patent Application Publication
(10) Pub. No.: US 2015/0071213 A1
(43) Pub. Date: Mar. 12, 2015

(54) Uplink Signalling Overhead

(71) Applicants: Kari Pekka Pajukoski, Oulu (FI); Kari Juhani Hooli, Oulu (FI); Esa Tapani Tiirola, Kempele (FI)

(72) Inventors: Kari Pekka Pajukoski, Oulu (FI); Kari Juhani Hooli, Oulu (FI); Esa Tapani Tiirola, Kempele (FI)

(21) Appl. No.: 14/399,014

(22) PCT Filed: May 14, 2012
(86) PCT No.: PCT/EP2012/058894

§ 371 Date: Nov. 5, 2014

(51) Int. Cl. H04W 72/04; H04L 12/925; H04B 7/06

(52) U.S. Cl. CPC H04W 72/0413; H04B 7/0632; H04L 47/722
USPC 370/329

(57) ABSTRACT

The invention relates to an apparatus including at least one processor and at least one memory including a computer program code, the at least one memory and the computer program code configured to, with the at least one processor, cause the apparatus at least to: convey a scheduling request, channel quality information and information on a transmission buffer status by using a same transmission format, wherein resources of the same transmission format used for reporting the channel quality information and the transmission buffer status depend on a content of an indication of the scheduling request.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In the Long Term Evolution (LTE) or Long Term Evolution Advanced (LTE-Advanced), buffer status information is used to inform an uplink packet scheduler about the amount of data buffered at a user device for transmission. Main uplink buffer status reporting mechanisms are a scheduling request (SR) and buffer status report (BSR).

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: obtain, in a same transmission format, a scheduling request, channel quality information and/or information on a transmission buffer status of a user device, wherein resources of the same transmission format used for reporting the channel quality information and the transmission buffer status depend on a content of an indication of the scheduling request.

According to an aspect of the present invention, there is provided an apparatus comprising: at least one processor and at least one memory including a computer program code, the at least one memory and the computer program code configured to, with the at least one processor, cause the apparatus at least to: convey a scheduling request, channel quality information and/or information on a transmission buffer status by using a same transmission format, wherein resources of the same transmission format used for reporting the channel quality information and the transmission buffer status depend on a content of an indication of the scheduling request.

According to yet another aspect of the present invention, there is provided a method comprising: obtaining, in a same transmission format, a scheduling request, channel quality information and/or information on a transmission buffer status of a user device, wherein resources of the same transmission format used for reporting the channel quality information and the transmission buffer status depend on a content of an indication of the scheduling request.

According to yet another aspect of the present invention, there is provided a method comprising: conveying a scheduling request, channel quality information and/or information on a transmission buffer status by using a same transmission format, wherein resources of the same transmission format used for reporting the channel quality information and the transmission buffer status depend on a content of an indication of the scheduling request.

According to yet another aspect of the present invention, there is provided an apparatus comprising: means for obtaining, in a same transmission format, a scheduling request, channel quality information and/or information on a transmission buffer status of a user device, wherein resources of the same transmission format used for reporting the channel quality information and the transmission buffer status depend on a content of an indication of the scheduling request.

According to yet another aspect of the present invention, there is provided an apparatus comprising: means for conveying a scheduling request, channel quality information and/or information on a transmission buffer status by using a same transmission format, wherein resources of the same transmission format used for reporting the channel quality information and the transmission buffer status depend on a content of an indication of the scheduling request.

According to yet another aspect of the present invention, there is provided a computer program embodied on a computer-readable storage medium, the computer program comprising program code for controlling a process to execute a process, the process comprising: obtaining, in a same transmission format, a scheduling request, channel quality information and/or information on a transmission buffer status of a user device, wherein resources of the same transmission format used for reporting the channel quality information and the transmission buffer status depend on a content of an indication of the scheduling request.

According to yet another aspect of the present invention, there is provided a computer program embodied on a computer-readable storage medium, the computer program comprising program code for controlling a process to execute a process, the process comprising: conveying a scheduling request, channel quality information and/or information on a transmission buffer status by using a same transmission format, wherein resources of the same transmission format used for reporting the channel quality information and the transmission buffer status depend on a content of an indication of the scheduling request.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 is another flow chart;

FIG. 4 illustrates examples of apparatuses, and

FIG. 5 illustrates other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Such required information is usually signalled to the (e)NodeB.

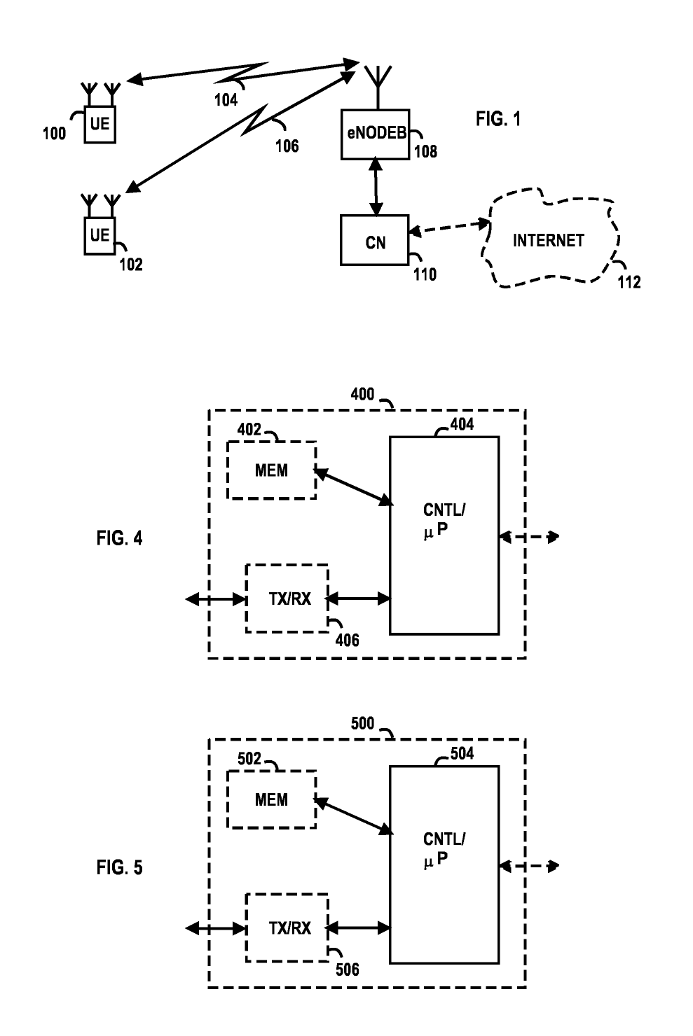

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells. Typically, in multilayer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)Node Bs has been introduced. Typically, a network which is able to use “plug-and-play” (e)Node (e)Bs, includes, in addition to Home (e)Node Bs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

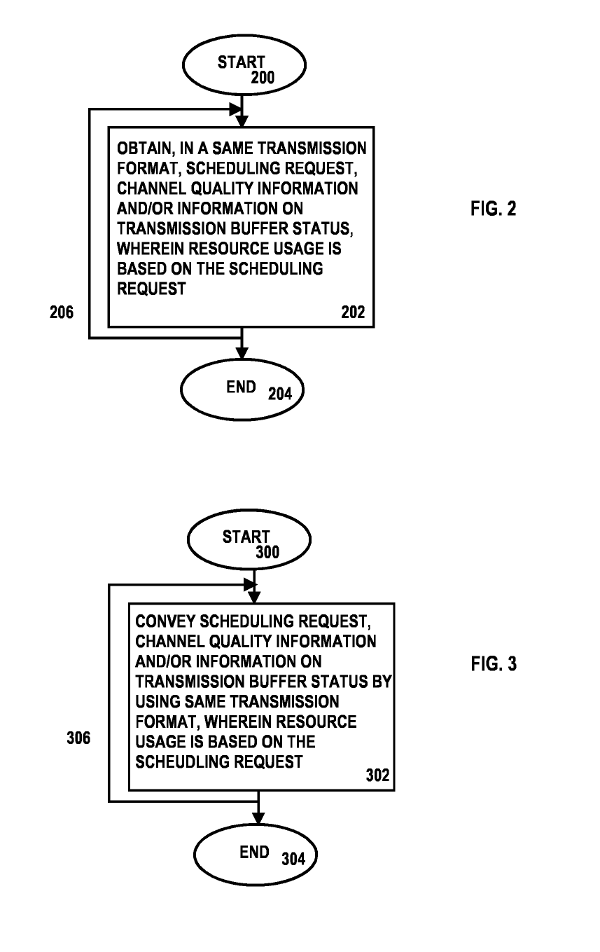

In the following, some embodiments are disclosed in further details in relation to FIGS. 2 and 3. Some embodiments are especially suitable for transmission of a scheduling request (SR), channel quality indicator (CQI) report and/or “preliminary” buffer status report (P-BSR).

In the LTE, a scheduling request (SR) mechanism is provided to enable a user device to request uplink transmission resources from a (e)NB. The scheduling request may be conveyed by using a dedicated resource on a physical uplink-control channel (PUCCH) as a single bit of information indicating that the user device has new data to transmit or as a random access-based scheduling request (RA-SR), where the SR is indicated by performing a random access procedure.

Since the SR procedure does not convey detailed information on the resource requirements of a user device, a buffer status report (BSR) with more detailed information may be conveyed with a first uplink transmission following the SR procedure.

A scheduling request (SR) is typically used to request physical uplink shared channel (PUSCH) resources and transmitted on a physical uplink control channel (PUCCH) by using one bit or using a random access procedure. According to Third Generation Partnership Project (3GPP) specifications, a scheduling request is transmitted as a consequence of triggering a “regular BSR”. A “regular BSR” may be triggered when uplink data arrives at a transmission buffer of a user device, which data belongs to a radio bearer group with a higher priority than earlier arrived data (or when the buffer is empty) or a serving cell change takes place.

A buffer status report (BSR) is typically transmitted using a medium access control (MAC) control (MAC-C) element in the case when resources are allocated to a user device on a PUSCH in a current transmission time interval (TTI) and a buffer status report has been triggered. A BSR may be transmitted as a MAC-C protocol data unit (PDU) with only a header, wherein a field length indicator is replaced with buffer status information.

A channel quality indicator (CQI) provides a (e)NodeB with channel quality information. Channel quality information may include a carrier level received signal strength indication (RSSI) and a bit error rate (BER).

Due to the payload of a scheduling request signalling is limited (typically only on/off information), a (e)NodeB has usually no knowledge about the current status of a user device's transmission buffer at the beginning of a connection. In LTE uplink (UL), channel quality indicator and scheduling request are typically transmitted by using separate PUCCH resources. This usually requires considerable amount of PUCCH resources in a cell, and thus impacts negatively on the system capacity in the uplink and uplink peak data rate as well.

When a (e)NB has no knowledge about the status of a user device's transmission buffer immediately after receiving a scheduling request, one possibility is to assign a small transport block (TB) and low modulation and coding scheme (MCS) values for user device transmission to ensure that the user device does not fall in a coverage limited situation. A report about buffer status and power headroom may be provided later on. A scheduler may also utilize path-loss measurements used for making handover decisions to estimate a maximum for a transport block size that a user device is able to transmit successfully. However, in most of the cases, resource allocation becomes oversized resulting in the waste of capacity. On the other hand, if the allocated resource is too small, it may lead to excessive latency and thus increase the consumption of limited control resources (such as those of a physical downlink control channel (PDCCH)) due to multiple consecutive physical uplink shared channel (PUSCH) allocations.

In the following, some embodiments for transmitting an uplink scheduling request (SR), channel quality indicator (CQI) report and/or a (preliminary) buffer status report (P-BSR) using a specific transmission format is explained. The specific transmission format may comprise a dedicated resource for scheduling request (SR) indication.

In the specific transmission format, the number of resources allocated for a CQI report may be determined according to the content of SR indication. In the case of a negative SR (no need for resources), remaining resources may be used for a CQI report, and in the case of a positive SR, resources may be either divided between a CQI report and a P-BSR (CQI size may be reduced and/or compressed) or remaining resources may be allocated to a BSR (CQI may be left out).

In one embodiment, information bits (or symbols) SR, CQI and BSR may be jointly coded by using a code word. One bit may be reserved for an SR indication and the remaining bits may be reserved for a CQI and/or (P-)BSR according to the value of the SR indication bit (explained later in relation to embodiments). In the case when bit error probability is not same for all bits, the bit having the lowest error probability is usually used for the SR indication.

Allocation granularity for uplink data on a PUSCH may be based on a (preliminary) BSR. The (P-)BSR may include a short buffer status report (or a further compressed form of it). In one embodiment, a single bit (P-)BSR is provided. The single bit indicates whether the amount of data ready for transmission is less (or more) than a threshold or comparison value. The threshold or comparison value may be adjustable and determined by a network, for example based on statistical information or simulations.

One embodiment may be carried out by a device configured to operate as a network apparatus, such as a server, (e) node or host or as a stand-alone scheduler which may also be provided as a cloud service, etc. The embodiment starts in block 200 of FIG. 2.

In block 202, a scheduling request, channel quality information and/or information on a transmission buffer status of a user device, are obtained in a same transmission format, wherein resources of the same transmission format used for reporting the channel quality information and the transmission buffer status depend on a content of an indication of the scheduling request.

It can be said that resource usage is based on a scheduling request. The indication of a scheduling request may be one bit in a code word or in a message.

A scheduling request and the information on a transmission buffer status of a user device may be received in a same message or code word or the scheduling request, a channel quality indicator and the information on the transmission buffer status may be received in a same message or code word.

In one embodiment, the resources are bits.

The information on the transmission buffer status may be called a (preliminary) buffer status report (P-)BSR. It may comprise only one bit indicating whether the amount of data ready for transmission is less (or more) than the obtained comparison value. Thus, the values may be “0” or “1”. Other possibilities for informing a buffer status naturally exist.

In one embodiment, information bits (or symbols) SR, CQI and BSR may be jointly coded by using one code word by a user device and thus received as one code word. In the code word, one bit may be reserved for a SR indication and the remaining bits may be reserved for a CQI (possibly compressed) and/or (P-)BSR according to the value of the SR indication bit (“0” or “1”, for example). In the case a bit error probability is not same for all bits, the bit having the lowest error probability is usually chosen for the SR indication.

In one embodiment, a comparison value for an amount of data in a transmission buffer is obtained. A comparison value may be updated “on-going” and determined by a network, for example based on statistical information or simulations. The comparison value may be in the form of a threshold value. A “start value” of it is typically determined in advance and transmitted to a scheduler or a device comprising it. The comparison value is typically a trade-off between an efficient capacity usage and the fluency of a service. The comparison value may be selected in such a manner that most of uplink packets are smaller than it. Typically, the comparison value is determined by higher layers, not by a physical layer.

Resources may be allocated according to a maximum amount of resources, if the information on the buffer status indicates that the amount of data is bigger than the comparison value. The maximum amount of resources may be based on path-loss measurements used for handover decisions or downlink channel quality indicator or some other information which may be related to service type or current traffic situation in the cell at issue. Otherwise, that is to say that if the information on the buffer status indicates that the amount of data is smaller than the comparison value, resources may be allocated to the extent of the comparison value.

The amount of allocation may be less or equal to the comparison value. The exact amount of resource allocation may vary case by case, depending on interference, distance, number of simultaneous users, etc. it should be appreciated that conventional resource allocation algorithms and methods may be used in combination of the embodiment. However, typically it is beneficial to keep this “preliminary” allocation simple and efficient.

The embodiment ends in block 204. The embodiment is repeatable in many ways. One example is shown by arrow 206 in FIG. 2. It should be appreciated that it is not necessary to obtain a comparison value every time resources are allocated.

Another embodiment which may be carried out by a user device or a corresponding device, will now be explained by means of FIG. 3. The embodiment starts in block 300.

In block 302, a scheduling request, channel quality information and/or information on a transmission buffer status are conveyed by using a same transmission format, wherein resources of the same transmission format used for reporting the channel quality information and the transmission buffer status depend on a content of an indication of the scheduling request.

It can be said that resource usage is based on a scheduling request. The indication of a scheduling request may be one bit in a code word or in a message.

A scheduling request and the information on a transmission buffer status of a user device may be conveyed in a same message or code word or the scheduling request, a channel quality indicator and the information on the transmission buffer status may be conveyed in a same message or code word.

In one embodiment, the resources are bits.

The information on the transmission buffer status may be called a (preliminary) buffer status report (P-)BSR. It may comprise only one bit indicating whether the amount of data ready for transmission is less (or more) than the obtained comparison value. Thus, the values may be “0” or “1”. Other possibilities for informing a buffer status naturally exist.

In one embodiment, information bits (or symbols) SR, CQI and BSR may be jointly encoded by using one code word. One bit may be reserved for a SR indication and the remaining bits may be reserved for a CQI (possibly compressed) and/or (P-)BSR according to the value of the SR indication bit (“0” or “1”, for example). In the case a bit error probability is not same for all bits, the bit having the lowest error probability is usually chosen for the SR indication.

In the case of a negative scheduling request, remaining resources may be used for reporting the channel quality information and in the case of a positive scheduling request, remaining resources may be divided between the channel quality information and the information on the transmission buffer status.

In one embodiment, resources may be allocated to the information on the transmission buffer status and the channel quality information is left out.

A user device may transmit the information listed above to a (e)NodeB.

A scheduling request may be triggered when uplink data arrives at a transmission buffer of a user device.

It should be appreciated that, if no data is ready for transmission, a scheduling request and a channel quality indicator may be conveyed.

The embodiment ends in block 304. The embodiment is repeatable in many ways. One example is shown by arrow 306 in FIG. 3.

Embodiments enable more efficient usage of system capacity due to improved and more accurate sizing of PUSCH resource allocations.

In embodiments, resources previously used for CQI transmission, in other words PUCCH format 2/2a/2b (or possibly also PUCCH format 3) or multiplexing on PUSCH may be used for transmission.

The steps/points, signaling messages and related functions described above in FIG. 2 or 3 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, transmitting and/or receiving may herein mean preparing a data conveyance, broadcast, transmission and/or reception, preparing a message to be conveyed, broadcasted, transmitted and/or received, or physical transmission and/or reception itself, etc. on a case by case basis. The same principle may be applied to terms transmission and reception as well.

An embodiment provides an apparatus which may be any node, host, server, web stick or any other suitable apparatus capable to carry out processes described above in relation to FIG. 2.

FIG. 4 illustrates a simplified block diagram of an apparatus according to an embodiment.

As an example of an apparatus according to an embodiment, it is shown apparatus 400, such as a node, including facilities in control unit 404 (including one or more processors, for example) to carry out functions of embodiments according to FIG. 2. The facilities may be software, hardware or combinations thereof as described in further detail below.

In FIG. 4, block 406 includes parts/units/modules needed for reception and transmission, usually called a radio front end, RF-parts, radio parts, radio head, etc.

Another example of apparatus 400 may include at least one processor 404 and at least one memory 402 including a computer program code, the at least one memory and the computer program code configured to, with the at least one processor, cause the apparatus at least to: obtain, in a same transmission format, a scheduling request, channel quality information and/or information on a transmission buffer status of a user device, wherein resources of the same transmission format used for reporting the channel quality information and the transmission buffer status depend on a content of an indication of the scheduling request.

Yet another example of an apparatus comprises means 404 (406) for obtaining, in a same transmission format, a scheduling request, channel quality information and/or information on a transmission buffer status of a user device, wherein resources of the same transmission format used for reporting the channel quality information and the transmission buffer status depend on a content of an indication of the scheduling request.

Yet another example of an apparatus comprises an obtaining unit configured to obtain, in a same transmission format, a scheduling request, channel quality information and/or information on a transmission buffer status of a user device, wherein resources of the same transmission format used for reporting the channel quality information and the transmission buffer status depend on a content of an indication of the scheduling request.

It should be understood that the apparatuses may include or be coupled to other units or modules etc., such as radio parts or radio heads, used in or for transmission and/or reception. This is depicted in FIG. 4 as optional block 406.

Although the apparatuses have been depicted as one entity in FIG. 4, different modules and memory may be implemented in one or more physical or logical entities.

An embodiment provides an apparatus which may be user device, such as a smart phone or any other suitable apparatus capable to carry out processes described above in relation to FIG. 3.

FIG. 5 illustrates a simplified block diagram of an apparatus according to an embodiment.

As an example of an apparatus according to an embodiment, it is shown apparatus 500, such as user device or web stick, including facilities in control unit 504 (including one or more processors, for example) to carry out functions of embodiments according to FIG. 3. The facilities may be software, hardware or combinations thereof as described in further detail below.

In FIG. 5, block 506 includes parts/units/modules needed for reception and transmission, usually called a radio front end, RF-parts, radio parts, radio head, etc.

Another example of apparatus 500 may include at least one processor 504 and at least one memory 502 including a computer program code, the at least one memory and the computer program code configured to, with the at least one processor, cause the apparatus at least to: convey a scheduling request, channel quality information and/or information on a transmission buffer status by using a same transmission format, wherein resources of the same transmission format used for reporting the channel quality information and the transmission buffer status depend on a content of an indication of the scheduling request.

Yet another example of an apparatus comprises means 504 (506) for conveying a scheduling request, channel quality information and/or information on a transmission buffer status by using a same transmission format, wherein resources of the same transmission format used for reporting the channel quality information and the transmission buffer status depend on a content of an indication of the scheduling request.

Yet another example of an apparatus comprises a conveying unit configured to convey a scheduling request, channel quality information and/or information on a transmission buffer status by using a same transmission format, wherein resources of the same transmission format used for reporting the channel quality information and the transmission buffer status depend on a content of an indication of the scheduling request.

It should be understood that the apparatuses may include or be coupled to other units or modules etc., such as radio parts or radio heads, used in or for transmission and/or reception. This is depicted in FIG. 5 as optional block 506.

Although the apparatuses have been depicted as one entity in FIG. 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be at least one software application, module, or unit configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1-44. (canceled)

45. An apparatus comprising:
at least one processor and at least one memory including a computer program code, the at least one memory and the computer program code configured to, with the at least one processor, cause the apparatus at least to:
obtain, in a same transmission format, a scheduling request, channel quality information and/or information on a transmission buffer status of a user device, wherein resources of the same transmission format used for reporting the channel quality information and the transmission buffer status depend on a content of an indication of the scheduling request.

46. The apparatus of claim 45, wherein the resources comprise bits.

47. The apparatus of claim 45, further comprising causing the apparatus to:
obtain a comparison value for an amount of data in the transmission buffer of the user device as a part of the information on the transmission buffer status.

48. The apparatus of claim 45, further comprising causing the apparatus to:
obtain a comparison value for an amount of data in the transmission buffer of the user device as a part of the information on the transmission buffer status, and
allocate resources according to a maximum amount of resources, if the information on the buffer status indicates that the amount of data is bigger than the comparison value, otherwise allocate resources to the extent of the comparison value.

49. The apparatus of claim 45, further comprising causing the apparatus to:
obtain a comparison value for an amount of data in the transmission buffer of the user device as a part of the information on the transmission buffer status, wherein the information on the transmission buffer status comprises one bit indicating whether amount of data ready for transmission is less or more than the obtained comparison value.

50. The apparatus of claim 45, wherein the scheduling request and the information on the transmission buffer status are received in a same message or code word.

51. The apparatus of claim 45, wherein the scheduling request, the channel quality indicator and the information on the transmission buffer status are received in a same message or code word.

52. The apparatus of claim 45, wherein the scheduling request, the channel quality indicator and the information on the transmission buffer status are received in a same message or code word and wherein one bit indicates the scheduling request.

53. An apparatus comprising:
at least one processor and at least one memory including a computer program code, the at least one memory and the computer program code configured to, with the at least one processor, cause the apparatus at least to:
convey a scheduling request, channel quality information and/or information on a transmission buffer status by using a same transmission format, wherein resources of the same transmission format used for reporting the channel quality information and the transmission buffer status depend on a content of an indication of the scheduling request.

54. The apparatus of claim 53, wherein the resources comprise bits.

55. The apparatus of 53, wherein in the case of a negative scheduling request, remaining resources are used for reporting the channel quality information.

56. The apparatus of claim 53, wherein in the case of a positive scheduling request, remaining resources are divided between the channel quality information and the information on the transmission buffer status

57. The apparatus of claim 53, wherein the resources of the same transmission format are allocated to the information on the transmission buffer status and the channel quality information is left out.

58. The apparatus of claim 53, further comprising causing the apparatus to:
encode the scheduling request, the information on the transmission buffer status and the channel quality indicator into one code word or
encode the scheduling request and the information on a transmission buffer status into one code word.

59. The apparatus of claim 53, wherein the information on the transmission buffer status comprises one bit indicating whether amount of data ready for transmission is less or more than the obtained comparison value.

60. The apparatus of claim 53, wherein one bit in the code word is reserved for the scheduling request.

61. The apparatus of claim 53, wherein one bit in the code word is reserved for the scheduling request and wherein if a bit error probability is not same for all bits, the bit having the lowest error probability is chosen for the scheduling request.

62. The apparatus of claim 53, further comprising causing the apparatus to:
trigger the scheduling request when uplink data arrives at a transmission buffer.

63. A method comprising:
obtaining, in a same transmission format, a scheduling request, channel quality information and/or information on a transmission buffer status of a user device, wherein resources of the same transmission format used for reporting the channel quality information and the transmission buffer status depend on a content of an indication of the scheduling request.

64. The method of claim 63, wherein the resources comprise bits.

65. The method of claim 63, further comprising:
obtaining a comparison value for an amount of data in the transmission buffer of the user device as a part of the information on the transmission buffer status.

66. The method of claim 63, further comprising:
obtaining a comparison value for an amount of data in the transmission buffer of the user device as a part of the information on the transmission buffer status, and
allocating resources according to a maximum amount of resources, if the information on the buffer status indicates that the amount of data is bigger than the comparison value, otherwise allocate resources to the extent of the comparison value.

67. The method of claim 63, further comprising:
obtaining a comparison value for an amount of data in the transmission buffer of the user device as a part of the information on the transmission buffer status, wherein the information on the transmission buffer status comprises one bit indicating whether amount of data ready for transmission is less or more than the obtained comparison value.

68. The method of claim 63, wherein the scheduling request and the information on the transmission buffer status are received in a same message or code word.

69. The method of claim 63, wherein the scheduling request, the channel quality indicator and the information on the transmission buffer status are received in a same message or code word.

70. The method of claim 63, wherein the scheduling request, the channel quality indicator and the information on the transmission buffer status are received in a same message or code word and wherein one bit indicates the scheduling request.

71. A method comprising:
conveying a scheduling request, channel quality information and/or information on a transmission buffer status by using a same transmission format, wherein resources of the same transmission format used for reporting the channel quality information and the transmission buffer status depend on a content of an indication of the scheduling request.

72. The method of claim 71, wherein the resources comprise bits

73. The method of claim 71, wherein in the case of a negative scheduling request, remaining resources are used for reporting the channel quality information.

74. The method of any preceding claim 71, wherein in the case of a positive scheduling request, remaining resources are divided between the channel quality information and the information on the transmission buffer status

75. The method of any preceding claim 71, wherein the resources of the same transmission format are allocated to the information on the transmission buffer status and the channel quality information is left out.

76. The method of any preceding claim 71, further comprising:
encoding the scheduling request, the information on the transmission buffer status and the channel quality indicator into one code word or
encoding the scheduling request and the information on a transmission buffer status into one code word.

77. The method of any preceding claim 71, wherein the information on the transmission buffer status comprises one bit indicating whether amount of data ready for transmission is less or more than the obtained comparison value.

78. The method of claim any preceding claim 71, wherein one bit in the code word is reserved for the scheduling request.

79. The method of claim 71, wherein one bit in the code word is reserved for the scheduling request and wherein if a bit error probability is not same for all bits, the bit having the lowest error probability is chosen for the scheduling request.

80. The method of any preceding claim 71, further comprising:
triggering the scheduling request when uplink data arrives at a transmission buffer.
